(19) United States
(12) Patent Application Publication
(10) Pub. No.: US 2002/0186957 A1
(43) Pub. Date: Dec. 12, 2002

(54) Personal video recorder with high-capacity archive

(76) Inventor: Henry Yuen, Pasadena, CA (US)

Correspondence Address: Gifford, Krass, Groh, Suite 400, 280 N. Old Woodward Ave., Birmingham, MI, 48009, US

(21) Appl. No.: 10/134,838

(22) Filed: Apr. 29, 2002

Related U.S. Application Data
(60) Provisional application No. 60/286,928, filed on Apr. 27, 2001.
(60) Provisional application No. 60/297,126, filed on Jun. 8, 2001.

(51) Int. Cl. H04N 5/92; H04N 5/781

(52) U.S. Cl. 386/46; 386/68; 386/125

(57) ABSTRACT

A hierarchy of memory types is used to increase the effective storage capacity in a personal video recorder (PVR). Such a system includes first and second memories for storing the program, with the second memory being characterized as having a lower cost-per-bit or substantially higher storage capacity as compared to the first memory. An indexing capability is provided for marking the program as it is recorded, enabling an operator to exercise one or more VCR-like controls over the program when viewed on the display device, the controls at least including a PAUSE/RESUME function, regardless of which memory was used to store the program. In the preferred embodiment, the first memory is a disk drive having separate write and read heads and controls enabling the system to read out the content of the drive simultaneously with the writing of incoming programming, and the second memory is a video tape recorder (VTR). The second memory may be a removable storage media, either digital or analog, including, without limitation, DVD-R, CD or optical disks.

### REFERENCE TO RELATED APPLICATIONS

This application claims priority from U.S. Provisional Patent Application Ser. Nos. 60/286,928, filed Apr. 27, 2001 and 60/297,126, filed Jun. 8, 2001, the entire content of both being incorporated herein by reference.

### FIELD OF THE INVENTION

This invention relates generally to video recording and reproducing and, in particular, to the use of a hierarchy of memory types to increase the effective storage capacity in personal video recorders, and the like.

### BACKGROUND OF THE INVENTION

Due to decreases in magnetic disk memory cost, it is now possible to record and replay live video broadcasts yet provide VCR-like features such as PAUSE, REWIND and FAST FORWARD. Such capabilities are described in U.S. Pat. No. 5,701,383, and embodied in commercial products from TiVo and Microsoft.

Such systems generally utilize a hard drive with separately controllable read and write heads to record a television program so that the user can view previously recorded portions of the received television signal while continuing to record the incoming signal, thereby enabling the functions usually associated with video cassette recorders. These devices, termed “personal video recorders” (PVRs) can also be programmed to record video programs in an unattended manner and to choose programs to be recorded based on either user commands or known user preferences.

In PVR systems, it is desirable to have a relatively large storage capacity to provide the VCR-like features during a prolonged period of reception. However, hard disk storage capacity is relatively expensive. When compressed in the popular MPEG formats, about one gigabyte of storage is required for each hour of recording. With a typical movie lasting about two hours, a very large and accordingly very expensive hard drive is required to provide a user with a reasonable choice of recorded programming.

Several persons may also share the use of a single PVR. If each user desires to store personally favorite programming, a large storage capacity is required. Moreover, the hard disk drive approach is still far from being economical to become a low-cost removable medium, which makes it impossible to match the theoretical infinite storage capacity of a removable media such as VCR or DVD-R.

### SUMMARY OF THE INVENTION

Broadly, this invention utilizes a hierarchy of memory types to increase the effective storage capacity in a personal video recorder (PVR), while reducing overall system cost by archiving video programming from faster-access input devices onto more cost-effective, typically high-capacity media. In addition to an input for receiving a video program and an output for delivering the program to a display device, video viewing and recording system according to the invention includes first and second memories for storing the program, with the second memory being characterized as having a lower cost-per-bit or substantially higher storage capacity as compared to the first memory. An indexing capability is provided for marking the program as it is recorded, enabling an operator to exercise one or more VCR-like controls over the program when viewed on the display device, the controls at least including a PAUSE/RESUME function, regardless of which memory was used to store the program.

In the preferred embodiment, the first memory is a disk drive having separate write and read heads and controls enabling the system to read out the content of the drive simultaneously with the writing of incoming programming, and the second memory is a video tape recorder (VTR). The VTR may be configured to record the incoming program simultaneously with the first memory, or may be connected to receive the overflow output of the hard drive.

The second memory may be a removable storage media, either digital or analog, including, without limitation, DVD-R, CD or optical disks. The system may further include an encryptor and decryptor for respectively encrypting and decrypting signals transferred to and from the first memory and the second memory.

### BRIEF DESCRIPTION OF THE INVENTION

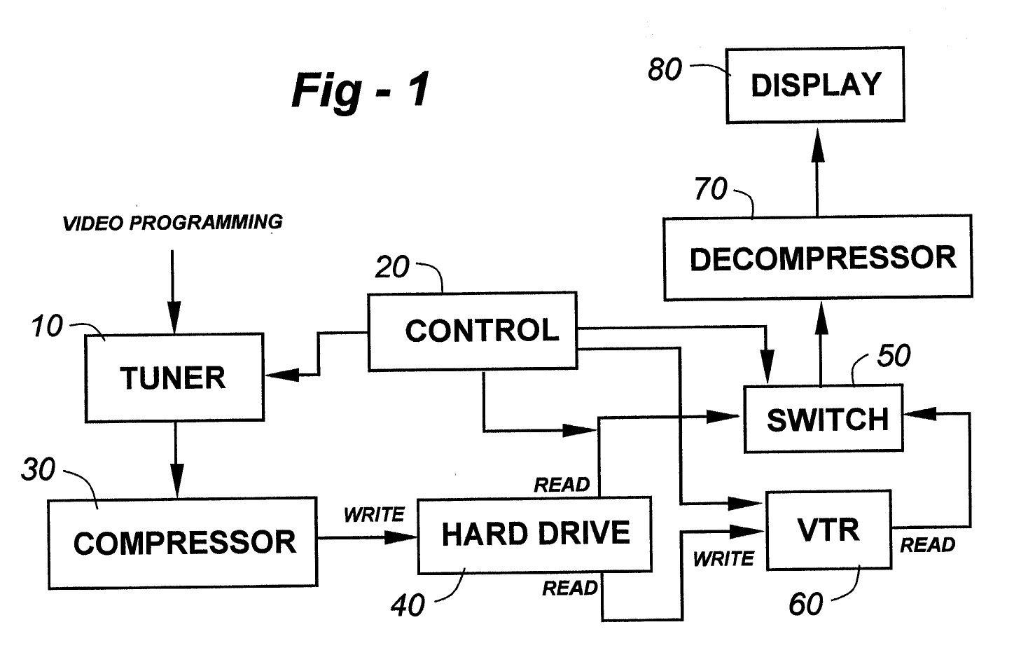

FIG. 1 is a block diagram depicting a preferred embodiment of the invention incorporating a disk/tape arrangement;

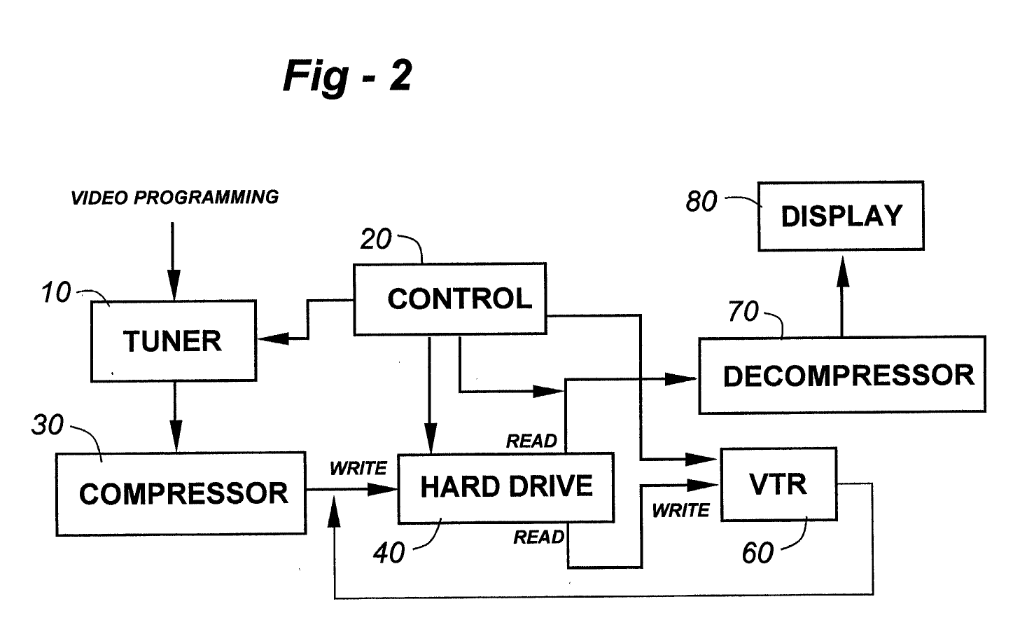

FIG. 2 shows an alternative embodiment in which all viewing of stored programming is implemented from a hard disk drive; and

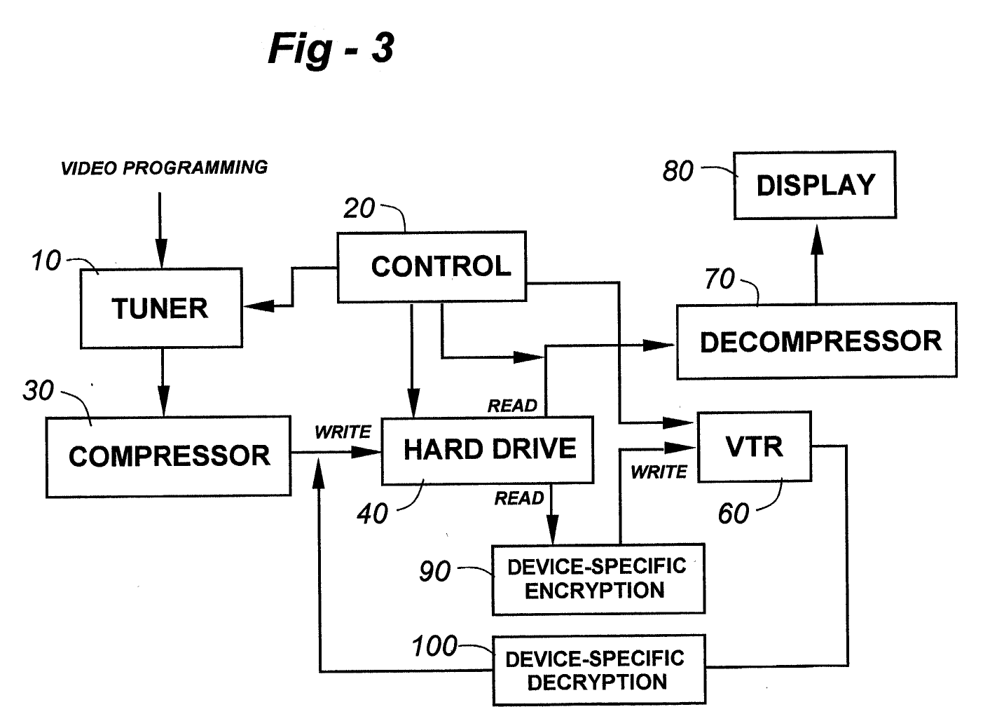

FIG. 3 shows a modified version of the embodiment of FIG. 2, employing specific device encryption.

### DETAILED DESCRIPTION OF THE INVENTION

According to the invention, incoming video programming is recorded onto a relatively high-speed, preferably random-access memory to facilitate instantaneous operator controls. At the same time, or perhaps following a delay depending upon the embodiment, the video programming is also recorded onto a more cost-effective archival storage medium typically characterized as having a higher capacity and/or lower access or seek time. For example, whereas the higher-speed memory is preferably randomly addressable, the archival storage medium may be serially addressable, but at a substantially reduced “cost per bit.” It is also desirable for the archival storage medium to be removable, thereby achieving the theoretically “infinite” storage capacity.

By balancing the amount of different memory types and by keeping track of record/replay timing, the invention causes a PVR to appear to have much more of the expensive memory type than it actually has, similar to “virtual memory” in some computer systems.

The practical implementation of the invention is a function of the level of technology and economics at a given time. For example, in accordance with current technology, the preferred embodiment combines a relatively small capacity hard drive with a videotape recorder (VTR). This enables a more extensive recording capacity enabled by the relatively low cost of tape storage compared with hard disk storage, and permits the consumer to create an archive of video recordings using a collection of removable cassettes.

The hard drive need only be large enough to store a reasonable portion such as one-half hour to an hour of a video program being recorded by the system off of live TV in order to provide the user with the convenience of random access memory, including pausing live-shows, rewinding live-shows, high-quality freeze frame, enhanced television with integrated data and video etc.

As economics permit, an alternative embodiment of the invention would use a “front end” implemented with a solid-state type of memory, such as flash random-access memory, with the archival storage being implemented in the form of a hard drive. Although “hard drive” currently implies magnetic storage, optical technology may alternatively be used assuming sufficiently fast read/write speeds. Similarly, the “back end” may encompass any storage media which is less expensive on a per-byte storage basis, or less spontaneous in random access capability (such as a DVD-R as opposed to hard disk or even a slower but removable hard disk); or conveniently removable for archival or transportation purposes. Nor is the invention limited to two level of storage, since a multi-level hierarchy (i.e., semiconductor, disk and tape) may also be implemented.

Incoming video may be simultaneously recorded onto each memory type, or the higher-speed media may be configured like a buffer or FIFO memory. Such a configuration may be particularly advantageous when the user has skipped through commercials or other unwanted material, thereby precluded the same from being archived. In addition, to further reduce archival storage requirements, the operator may be queried with an on-screen prompt, for example, asking whether to archive the material or not, or these functions could be performed automatically. Such a capability would be useful when a viewer would like VCR-like control over an incoming signal while knowing, in advance, that they do not wish to save the program (i.e., the nightly news).

To ensure that desired replay/erase functions are carried out accurately, index codes are preferably added to the program material during the recording process, whether such recording is simultaneous or delayed. If the higher-speed memory is used as a buffer, it may be important to use multiple read/write heads or separate media in conjunction with the archival storage to ensure that viewing is properly restarted with continuous archiving, particularly following a PAUSE command.

For example, if a PAUSE is sufficiently prolonged that the live broadcast is only available on the archival memory, the archival memory may incorporate multiple read/write heads to maintain the VCR-like functions while continuing to record, as described in U.S. Pat. No. 5,701,383. More particularly, a semiconductor front end may be backed-up with a multi-head magnetic (or optical) disk, or a multi-head magnetic (or optical) disk may itself be backed-up with a multi-head VTR and variable-length loop bin. Alternatively, multiple disk or VTR recorder/reproducers, including removable media, may be used to implement the multi-head functionality.

When a program has been recorded the program may be viewed at a later time in a conventional manner using the PAUSE, REWIND and FAST FORWARD functions of a tape recorder. Indexing is preferably implemented with a system of the type disclosed in U.S. Pat. No. 6,091,884 to Yuen et al. to allow convenient accessing of multiple programs stored on the archive, or to mark points on the stored program of interest to the user such as a point where the display was “paused” during viewing of that program. This allows a PAUSE to be initiated while a program section is on disk and to be “unpaused” after that section transferred to the archival storage means.

The hard drive or other random-access memory may also be used for convenient viewing of previously recorded programming which is archived on tape or slower archival media by feeding the output of the tape read head into the hard drive buffer. This enables quicker accessing of remote sections of the programming than could be achieved solely using the tape.

The tape storage capacity is preferably some multiple of the storage capacity of the hard disk. For example, the hard disk may have a storage capacity of one hour and the tape a storage capacity of ten-twenty hours, thus enabling it to store a wide variety of programming including movies. In view of the fact that VCR storage, for example, can be theoretically “infinite” in that numerous tapes can be used, this is not a limitation of the invention, but merely an illustration of the concept.

In embodiments of the invention in which the “front end” hard drive or other random-access memory utilizes a non-removable storage media and the “back end” or large capacity, slow access storage, typically tape, involves a removable media such as DVD-R or tape cassettes, when the information is copied from the non-removable to the removable media, a device specific encryption is preferably applied to the information so that it can only be played back on the same “front end” from which is was recorded. This will minimize the possibility of unauthorized digital reproduction. Alternatively, the encryption will be such that the recording on the removable media can be played back on a different unit than the one from which it was recorded if a suitable form of digital rights management authorization is employed. One form of authorization is disclosed in U.S. Pat. No. 6,135,646.

A block diagram of a disk/tape embodiment of the invention is illustrated in FIG. 1. A source of video programming such as an antenna, CATV, cable or satellite dish provides video programming to a tuner 10. A control unit 20 provides a signal to the tuner 10 controlling its channel setting. The output of the tuner 10 is provided to a compressor 30 which may enable MPEG or other compression techniques. If the input signal is in analog form, the compressor 30 will include an analog-to-digital converter. Alternatively, the video programming may be transmitted in a compressed digital form, eliminating the need for the compressor 30.

The output of the compressor 30 is provided to a write head of a hard drive 40. The hard drive preferably employs two read heads, although in alternative embodiments a single read head could be time-shared depending on device performance. One read output is controlled by the operator via the control 20 and is provided to a switch 50. The other read output represents the output of the first-in, first-out buffer constituted by the hard drive 40. That is, assuming the buffer 40 is of one gigabyte capacity, it can thus store about an hour compressed programming. After one hour's programming has been received from the compressor 30, the output of the hard drive, representing the beginning of the program, is provided to the write head of a videotape recorder 60.

The VTR is preferably a cassette recorder so that the tape can be replaced, but in any event should be able to store a number of hours of programming. The read head on the VTR 60 is provided to the switch 50. The control 20 uses the switch 50 to choose either the first read head of the hard drive or the read head of the VCR, which is provided to a decompressor 70 and then to a video display 80. The output of the first read head of the hard drive 40 is chosen by the switch 50 if the viewer is watching a program being received in real time. Alternatively, the VTR may be replaced, for example, by a removable digital storage device such as a DVD-R or CD (Write Once or many time) as well as other storage media fitting the purpose of functioning as an archival device.

By appropriate control of that first read head, the operator, using the control 20, can simply view the program almost simultaneously with it being received, based only upon the minimum separation between the write head and the first head of the VCR, or can enable PAUSE, FAST FORWARD, or REWIND functions. During these functions, the programming being received is continually recorded. When a PAUSE function is invoked, the system marks the point at which pause occurs so that when PAUSE is deactivated the program can be viewed from the pause point. If that point has advanced to storage on the VTR 60 before the pause has been terminated, the pause point is indexed.

The present invention thus allows the PAUSE, REWIND and FAST FORWARD function to be exercised on programming while that programming is continuously recorded by the hard drive 40 while allowing a wide variety of programming to be stored in the VTR without the need for a large hard drive.

An alternative embodiment of the invention in which all viewing of stored programming is implemented from the hard drive is illustrated in FIG. 2. In the embodiment of FIG. 2, the subassemblies are the same as in the first embodiment and are numbered in the same way. The system differs in that all video to be shown in the display 80 is derived from the first read head of the hard drive 40, which feeds through the compressor 70. The second read head of the hard drive 40, representing the overflow output of the hard drive, is provided to the VTR 60, along with any necessary indexing markers from the control 20.

When the operator calls for display of programming that is stored wholly within the VTR 60, the output of the VTR is read into the hard drive, in the same manner as real time video programming. This allows the operator to enjoy all advantages of the ready availability of programming stored on the hard drive, such as the ability to quickly jog in order to skip commercials and the like. While the same operations might be performed on the video tape recorder 60, they are inherently slower.

FIG. 3 illustrates another alternative embodiment of the invention of the type illustrated in FIG. 2 but further including circuitry for applying a device specific encryption to data transferred from the hard drive 40 to the tape recorder 60 which prevents that information from being displayed on a different system without somehow engaging a form of digital writes management. This is applicable to embodiments wherein the mass storage unit 60 has removable media and prevents the unauthorized digital reproduction of material. The system includes a device specific encryptor 90 which receives the read output from the hard drive 40 before it is sent to the VTR 60 and encrypts it with a code that must be decoded before the signal can be played. A complimentary decryptor 100 receives the output of the VTR 60 which is applied to the write head of the hard drive 40 to allow the encrypted material to be played back from the hard drive.

Having thus described my invention, I claim:

1. A video viewing and recording system, comprising:
an input for receiving a video program, and an output for delivering the program to a display device;
first and second memories for storing the program, the second memory being characterized as having a lower cost-per-bit or substantially higher storage capacity as compared to the first memory; and
an indexing capability for marking the program as it is recorded, enabling an operator to exercise one or more VCR-like controls over the program when viewed on the display device, the controls at least including a PAUSE/RESUME function, regardless of which memory was used to store the program.

2. The viewing and recording system of claim 1, wherein the first memory is a disk drive having separate write and read heads and controls enabling the system to read out the content of the drive simultaneously with the writing of incoming programming.

3. The viewing and recording system of claim 1, wherein the second memory is a video tape recorder (VTR).

4. The viewing and recording system of claim 3, wherein the VTR is connected to receive the overflow output of the hard drive.

5. The viewing and recording system of claim 1, wherein at least the second memory is a removable storage media, either digital or analog, including, without limitation, DVD-R, CD or optical disks.

6. The viewing and recording system of claim 1, wherein the first memory is a hard drive having separate write and read heads and controls for the write and read heads so as to be able to read out the content of the hard drive simultaneously with the writing of incoming programming into the hard drive.

7. The system of claim 1, wherein the display device may be controlled to view programming stored on either memory.

8. The system of claim 1, wherein at least the first memory is randomly addressable.

9. The system of claim 1, wherein the second memory is serially addressable.

10. The system of claim 1, wherein the first memory has a non-removable storage media and the second memory has a removable storage media. .

11. The system of claim 10, further including an encryptor and decryptor for respectively encrypting and decrypting signals transferred to and from the first memory and the second memory.

12. A video viewing and recording system, comprising:
an input for receiving a video program, and an output for delivering the program to a display device;
a first memory being randomly addressable;
a second memory being serially addressable; and
an indexing capability for marking the program as it is recorded, enabling an operator to exercise one or more VCR-like controls over the program when viewed on the display device, the controls at least including a PAUSE/RESUME function, regardless of which memory was used to store the program.

13. The viewing and recording system of claim 12, wherein the first memory is a disk drive having separate write and read heads and controls enabling the system to read out the content of the drive simultaneously with the writing of incoming programming.

14. The viewing and recording system of claim 12, wherein the second memory is a video tape recorder (VTR).

15. The viewing and recording system of claim 14, wherein the VTR is connected to receive the overflow output of the hard drive.

16. The viewing and recording system of claim 12, wherein at least the second memory is a removable storage media, either digital or analog, including, without limitation, DVD-R, CD or optical disks.

17. The viewing and recording system of claim 12, wherein the first memory is a hard drive having separate write and read heads and controls for the write and read heads so as to be able to read out the content of the hard drive simultaneously with the writing of incoming programming into the hard drive.

18. The system of claim 12, wherein the display device may be controlled to view programming stored on either memory.

19. The system of claim 12, wherein the first memory has a non-removable storage media and the second memory has a removable storage media.

20. The system of claim 12, further including:
an encryptor and decryptor for encrypting and decrypting signals transferred to and from the first memory and the second memory.
